(19) United States
(12) Patent Application Publication
(10) Pub. No.: US 2010/0151792 A1
(43) Pub. Date: Jun. 17, 2010

(54) WIRELESS COMMUNICATION SYSTEM AND A WIRELESS COMMUNICATION APPARATUS

(76) Inventor: Nobuyuki ISHIOKA, Nishitokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/611,974

(22) Filed: Nov. 4, 2009

(30) Foreign Application Priority Data
Dec. 17, 2008 (JP) 2008-320412

(51) Int. Cl. H04B 1/00

(52) U.S. Cl. 455/63.4

(57) ABSTRACT

For provide a wireless communication system and a wireless communication apparatus, for enabling preferable wireless transfer, reducing the time taken for adjustment of the beam direction, even in the case where the wireless transfer is conducted between the apparatuses installed within the room, etc., according to the present invention, there is provided a wireless communication system comprising a first wireless communication apparatus and a second wireless communication apparatus. The first wireless communication apparatus comprises a first antenna, which is able to control a beam into a plural number of directions, a first estimate portion, which estimates a network quality of a wireless network with using a radio wave transmitted from the second wireless communication apparatus, a first memory portion, which memorizes a beam pattern information including information indicative of priorities of the plural number of beam directions upon basis of the network qualities estimated by the first estimate portion, and a first controller portion, which controls the first antenna, the first estimate portion and the first memory portion. And, the first controller portion controls the beam direction of the first antenna upon basis of the beam pattern information memorized in the first memory portion.

### INCORPORATION BY REFERENCE

This application claims the benefit of priority of Japanese Application No. 2008-320412 filed on Dec. 17, 2008, the disclosure of which also is incorporated herein by reference.

### BACKGROUND OF THE INVENTION

The present invention relates to a wireless communication system for conducting communication between apparatuses, such as, a tuner unit and a display, etc., with using an antenna, which can dynamically control a beam direction (directivity) thereof.

In case when conducting wireless transfer between the apparatus, such as, the tuner unit and the display apparatus, etc., for example, there is necessity of searching a wireless network of normally enabling the wireless transfer, by controlling the beam direction (directivity) of the antennas of both of them. However, during the time when searching the wireless network for normally enabling the wireless transfer, since it is impossible to conduct the wireless transfer, if it takes long time for that search, therefore this brings about a problem that it gives a large amount of stress to a user.

In the following Patent Document 1 is disclosed a mobile station, conducting the wireless communication between a base station with using the antenna, which can dynamically control the directivity thereof, extracts directivity control data corresponding to a position detected when detecting the position of the station itself by means of a position detect means, such as, a GPS (Global Positioning System), etc., and according to the directivity control data extracted, it control the directivity of the antenna. Also, in the following Patent Document 2 is disclosed a receiver for receiving a broadcast wave of broadcasting of a predetermined channel, which is transmitted from a broadcasting station or a relay station, by means of a directivity changeable antenna.

[Patent Document 1] Japanese Patent Laying-Open No. 2001-94496 (2001); and

[Patent Document 2] Japanese Patent Laying-Open No. 2006-25321 (2006).

### BRIEF SUMMARY OF THE INVENTION

With the method described in the Patent Document 1, though applying the GPS for controlling the directivity of the antenna, but in case where the apparatuses, such as, the tuner unit and/or the display, etc., are installed within a room or a narrow region, there is a possibility that the GPS cannot be measured or control is difficult due to an error of measurement.

Also, the Patent Document 2 mentions about the receiving system of broadcast wave(s), which is/are transmitted from the broadcast station and/or the relay station. When receiving radio wave of the broadcast station and/or the relay station, if an auto-direction scan is completed, once, the radio wave is scarcely disturbed by an obstruction, for a moment. On the other hand, in a system, in which the wireless transfer is conducted between the display and the tuner unit, which are disposed within the room, etc., there is a possibility of generating network abstractions frequently due to movement of a human being, etc. Further, with the Patent Document 2, since it is assumed that the broadcast wave is received therewith, and the broadcast wave is able to use a predetermined frequency, exclusively, therefore interference hardly occurs between other wireless or radio systems. However, in a system conducting the wireless transfer within a room, for example, since it uses a frequency band where many other wireless systems and/or radio noise sources also exist, in many cases, it is necessary to take measures to the interferences from other wireless system(s), and/or also the interferences given to the other wireless system(s). However, the Patent Document 2 never mentions about the countermeasures to those, therein.

For that reason, a wireless communication system is desired, for enabling favorable wireless transfer between the apparatuses, such as, the tuner unit and the display, etc., which are installed within a room, etc., for example.

According to the present invention, an object thereof is to provide a wireless communication system and a wireless communication apparatus, for enabling preferable wireless transfer, reducing the time taken for adjustment of the beam direction, even in the case where the wireless transfer is conducted between the apparatuses installed within the room, etc.

According to the present invention, for accomplishing the object mentioned above, there is provided a wireless communication system, comprising: a first wireless communication apparatus; and a second wireless communication apparatus, wherein the first wireless communication apparatus comprises: a first antenna, which is able to control a beam into a plural number of directions; a first estimate portion, which estimates a network quality of a wireless network with using a radio wave transmitted from the second wireless communication apparatus; a first memory portion, which memorizes a beam pattern information including information indicative of priorities of the plural number of beam directions upon basis of the network qualities estimated by the first estimate portion; and a first controller portion, which controls the first antenna, the first estimate portion and the first memory portion, wherein the first controller portion controls the beam direction of the first antenna upon basis of the beam pattern information memorized in the first memory portion.

According to the present invention mentioned above, it is possible to provide a wireless communication system and a wireless communication apparatus for enabling preferable wireless transfer, reducing the time taken for adjustment of the beam direction, even in the case where the wireless transfer is conducted between the apparatuses installed within the room, etc.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an example of the configuration of a wireless communication system, according to an embodiment of the present invention;

FIG. 2 is a view for showing an example of installing a tuner unit and a display within a room;

FIG. 3 is a block diagram for showing an example of the structure of an adaptive array antenna;

FIG. 4 is a flowchart for showing an example of a control method for adjusting a beam direction;

FIG. 5 is a view for showing an example of a combination of beam patterns of the adaptive array antenna;

FIG. 6 is a flowchart for showing an example of processing in a preparatory search;

FIG. 7 is a view for showing an example of beam pattern information;

FIG. 8 is a view for showing an example of beam pattern information;

FIG. 9 is a view for showing an example of a control method for adjusting the beam direction;

FIG. 10 is a flowchart for showing an example of processing of a carrier sense;

FIG. 11 is a flowchart for showing an example of a control method for adjusting the beam direction;

FIG. 12 is a view for showing an example of beam pattern information; and

FIG. 13 is a flowchart for showing an example of a control method for adjusting the beam direction.

### DETAILED DESCRIPTION OF THE PREFERRED EMBODIMENTS

Hereinafter, embodiments according to the present invention will be fully explained by referring to the attached drawings.

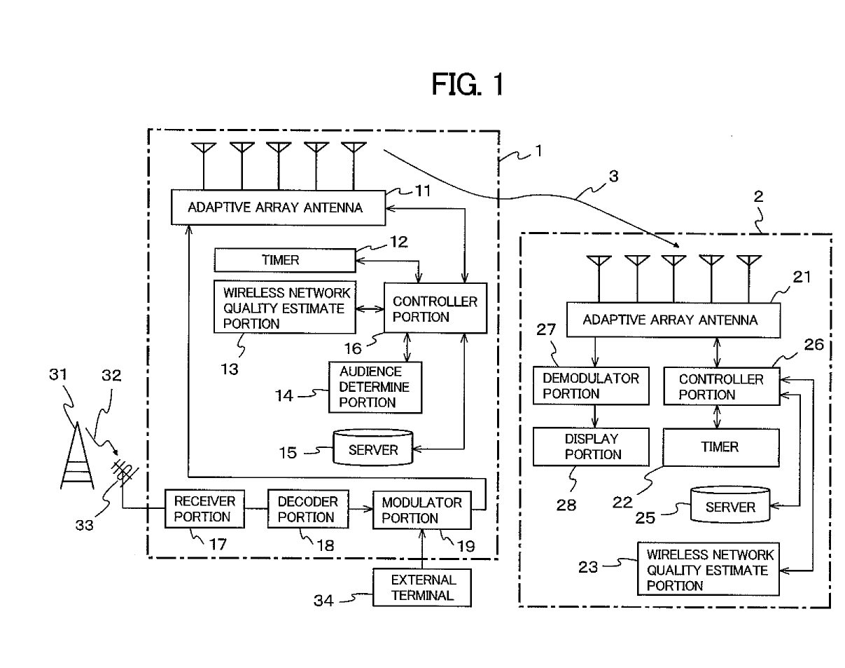

FIG. 1 is a view for showing an example of the configuration of a wireless communication system. In the present system, data is wirelessly transferred between a tuner unit 1 and a display 2, through a wireless network 3. Herein, the data to be wirelessly transferred includes, not only video data, but also audio data, EPG (Electronic Program Guide) and control signals for normally conducting the wireless transfer, etc., therein.

The tuner unit 1 receives a television broadcast wave 32, and after extracting video data from that television broadcast wave 32, transfers the video data, in a wireless manner, to the display 2.

In general, when conducting the wireless transfer of the video data, a microwave band (being equal to or greater than several GHz, such as, 60 GHz, for example), within which a frequency band can ensured to be wide, relatively. For that reason, in the present example, explanation will be made on a case where a microwave network is used as the wireless network 3; however, the wireless network should not be limited only to this.

First of all, explanation will be made briefly, on the wireless communication system for transferring the video data, wirelessly.

The television broadcast wave 32, which is transmitted from a television broadcast station 31, is received upon a receiver portion 17, through a television broadcast wave-receiving antenna 33. The television broadcast wave 32 received upon the receiver portion 17 is demodulated, and in a decoder portion 17 is extracted video data from the demodulated signal. The video data extracted, after being demodulated into a signal of the microwave band by a modulator portion 19, is transmitted by means of an adaptive array antenna 11, and thereby being transmitted to the display 2 through the wireless network 3.

The video data transferred wirelessly by the tuner unit 1 is received upon an adaptive array antenna 21 on the side of the display 2, and the video data is extracted from the signals of microwaves by means of the demodulator portion 27. The video data demodulated is displayed on a display portion 28. Further, as the display portion 28 may be used a plasma display, a liquid crystal display, a CRT (Cathode Ray Tube) display, etc., for example.

Further, in FIG. 1, the television broadcast station 31 is only an example, and in the place of that from the television broadcast station 31 may be received the broadcast wave from, such as, a radio broadcast station and/or a center station of CATV, etc., for example. Also, with provision of an external input terminal 34 on the tuner unit 1, the video data inputted from the external input terminal 34 may be wirelessly transferred to the display 2.

The adaptive array antennas 11 and 21 are antennas, the directivity of which can be controlled, dynamically. With use of the adaptive array antenna, it is possible to direct a main lobe is of the antenna directivity to a target wave desired (i.e., beam forming), and to remove an unnecessary interference wave by directing a null point (i.e., a zero point) thereto (i.e., an adaptive null steering). However, this adaptive array antenna is only an example, and the present invention should not be restricted only to this. For example, in the place of the adaptive array antenna, a phased array antenna or the like may be used therein, as far as being an antenna enabling to control the directivity thereof, mechanically or electrically.

A timer 12 provided in the tuner unit 1 and a time 22 provided in the display 2 are time-synchronized with each other, and they make decision on whether it is the time or not, which was determined in advance.

A network quality estimate portion 13, which is provided in the tuner unit 1, as well as, a network quality estimate portion 23, which is provided in the display 2, estimate the network quality of the wireless network 3, respectively. As a method for estimating the network quality are already known the following methods of using, for example, a strength of radio wave received, a rate of a number of packets received with respect to that of packets transmitted (i.e., a Packet Error Rate), a ratio of a target wave with respect to the interference wave, on the strength of radio wave received (i.e., a Desired to Undesired Signal Ratio), etc. However, those are only an example, but the estimation may be made with using other method(s), as for as being able to estimate the network quality of the wireless network 3. Hereinafter, as an example, explanation will be given on a method for estimating the network quality of the wireless network 3 with using the strength of radio wave received, in the details thereof.

The network quality estimate portion 23, upon receipt of the radio wave (i.e., the video data) transmitted from the adaptive array antenna 11, estimates the network quality of the wireless network 3, by measuring the strength of radio wave received with using the radio wave, which is received. Also, the network quality estimate portion 13, upon receipt of the radio wave transmitted from the adaptive array antenna 21, estimates the network quality of the wireless network 3, by measuring the strength of radio wave received with using the radio wave, which is received. However, in case where the frequency of transmitting/receiving is equal to, since the wireless network quality is at the same level, in general, therefore the network quality estimate portion may be provided only either in the tuner unit 1 or the display 2, thereby measuring the network quality on one side of them.

An audience determine portion 14, which is provided in the tuner unit 1, determines on whether the information is in the condition of “in audience”, or not, i.e., being displayed on the display. Herein, within the “in audience” are included, not only the condition of displaying the contents, such as, a drama or a movie, etc., on a screen, wherein the video data is wirelessly transferred directing from the tuner unit 1 to the display 2, but also a receipt waiting condition of waiting a selection input of the video data inputted by a user, wherein the information, such as, a menu list, etc., is displayed thereon, but the video information is not yet transferred, wirelessly. However, in the present example, explanation was given on the case where the data to be transferred is the video data; the present invention should not be limited only to this, it may be other data, such as, audio data or the like, for example. Also, in case where other wireless communication apparatus is applied in the wireless communication system in the place of the display 2, the “in audience” should include a condition where the data, such as, the video data and/or the audio data are transferred, and also a condition of waiting the selection input of data, the transfer of which is required by the user, irrespective of the fact that the picture is displayed on the screen or not. Also, though the tuner unit 1 includes the audience determine portion 14 therein, however the audience determine portion may be provided within the display 2, or both of them. Also, the audience determine portion may be mounted on an external apparatus other than the tuner unit 1 and the display 2, for example, a remote controller, etc.

A controller portion 16 provided in the tuner unit 1 controls each of the components; such as, the adaptive array antenna 11, the timer 12, the wireless network estimate portion 13, the audience determine portion 14, and a server 15, etc. Also, a controller portion 26 provided in the display 2 controls each of the components; such as, the adaptive array antenna 21, the time 22, the wireless network estimate portion 23, and a server 25, etc.

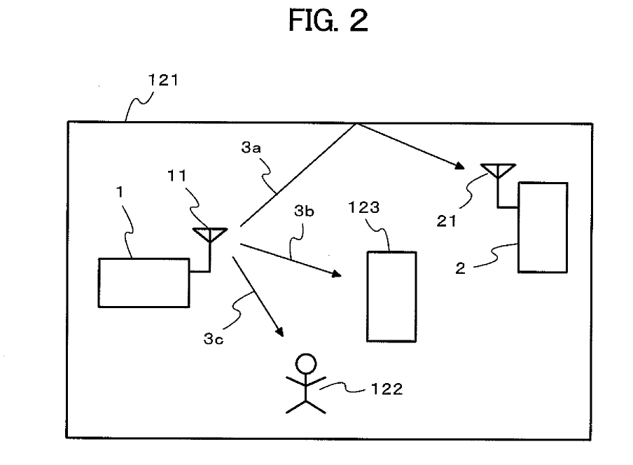

Next, explanation will be given on a problem of the wireless transfer with using the microwave, referring to FIG. 2 attached. FIG. 2 is a view for showing an example of providing the tuner unit 1 and the display 2 within a room.

The microwave has a characteristic, i.e., being strong in the progressiveness thereof, and in general, the tuner unit 1 and the display 2 are installed at a low position, such as, on a floor or the like, for example, in many cases. For this reason, the radio wave transmitted by the tuner unit 1 is interrupted by an obstruction, such as, a furniture, etc., and in many cases, the wireless transfer is conducted between the tuner unit 1 and the display 2, with using reflection waver upon a wall surface and/or a ceiling surface, rather than the radio wave reaches to the display 2, directly. However, in case where one of the tuner unit 1 and the display 2 is in another room or in an outside of the room, then a transmission wave is used.

In the example shown in FIG. 2, for the wireless transfer with using a wireless network 3b, it is difficult to make a normal transfer, because of an obstruction of furniture 123. Also, for the wireless transfer with using the wireless network 3c, it is difficult to make a normal transfer, because of an obstruction of a human being 122. On the other hand, for the wireless transfer with using the wireless network 3a, it is possible to make a normal transfer, by reflecting the microwave on an interior wall 121.

In this manner, it is necessary to conduct the wireless transfer by searching out one from a plural number of wireless networks 3, the network quality of which is equal or larger than a predetermined value (herein, the predetermined value indicates a quality level, at which the wireless transfer can be made, and it is a value determined in advance). By controlling the directivity (i.e., beam forming) of the adaptive array antennas of both the tuner unit 1 and the display 2, it is possible to make a search on the radio wave quality. However, during the time when searching the wireless network, since the wireless transfer cannot be made, it is possible to display the picture on the display. The search of this wireless network takes a certain time, and then this brings about a problem of giving a large amount of stress onto the user. Further, there can be considered a case of momentarily changing of an environment of the radio wave, due to movement of the human being and open/close of a door, etc., for example, such as, in the case of the wireless network 3c wherein the human being 122 interrupts the wireless network. If the search is repeated every time when such deterioration of the network quality occurs, it results in a large ill influence upon a viewing of the picture by the user.

For resolving this problem, according to the present system, trials are made on all the beam patterns, which can be made by the adaptive array antennas 11 and 21, in advance, and estimation is made on the quality of each of the wireless networks. And, it is characterized in that the beam pattern information are reserved into the servers 15 and 25, respectively, and with using those beam pattern information, the directivity of the adaptive array antennas are controlled. With controlling in this manner, even if an obstruction occurs on the wireless network during the time of the wireless transfer, it is possible to suppress the network obstruction to the minimum, by reforming the beam patterns of the adaptive array antennas, immediately, upon basis of the beam pattern information recorded in the servers 15 and 25. Herein, the beam pattern information means the information indicating the beam direction (i.e., the directivity) of the adaptive array antennas 11 and 21.

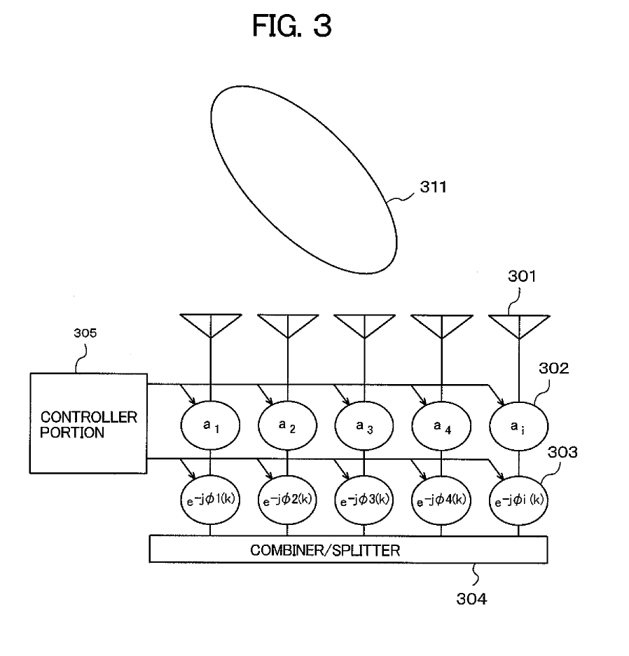

FIG. 3 shows an example of the structures of the adaptive array antennas 11 and 21. The adaptive array antenna is constructed with a plural number (an integer equal to or greater than 2) of antenna elements 301, variable amplifiers 302, and variable phase shifters 303, and a combiner/splitter 304 and a controller portion 305. The adaptive array antenna is able to control the directivity (i.e., the beam direction), dynamically, by controlling phase and amplitude of the radio wave, which are transmitted/received upon the plural number of antenna elements 301. In this manner, since the phase and the amplitude of the radio wave determine the directivities of the adaptive array antennas 11 and 21, then setup values of the variable amplifiers 302 and the variable phase shifters 303 are recorded, for each of the directivities, into the beam pattern information. However, in FIG. 3 is illustrated only the structures, being necessary at the lowest for controlling the directivities, dynamically, but a frequency converters and ADC (Analog Digital Converter), etc., are omitted herein.

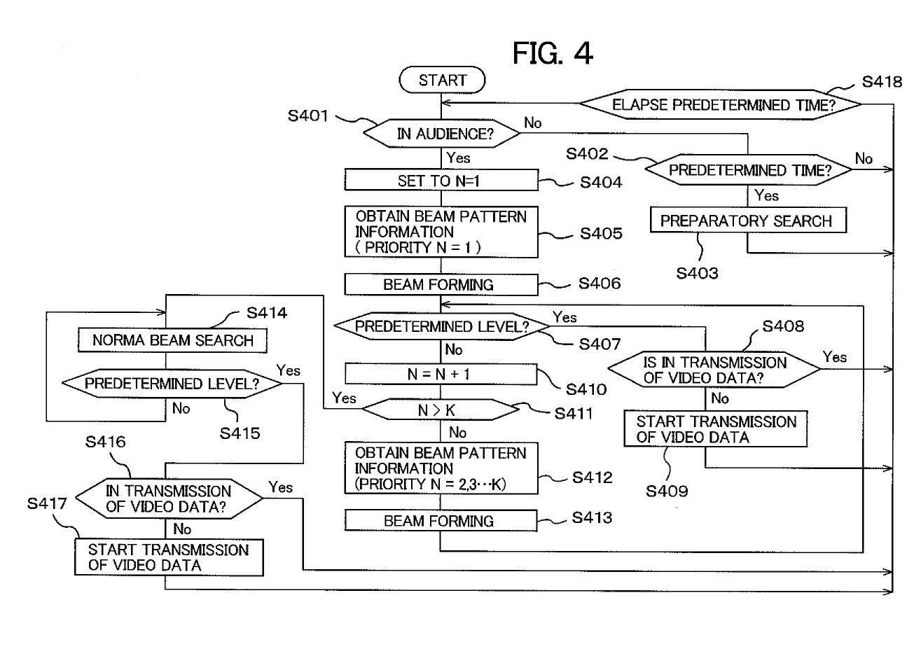

FIG. 4 is a flowchart for showing an example of a control method for adjusting the beam direction. When a power source of the tuner unit is turned ON, then the controller portion 16 starts a program for executing the flowchart shown in FIG. 4.

First of all, as a starting process, the tuner unit 1 transmits a time synchronization signal, which is produced by the timer 12, for the purpose of synchronizing the timers 12 and 22, directing to the display 2. If not receiving a signal indicative of capture of synchronization from the display 2, the controller portion 16 transmits the time synchronization signal for every predetermined period, for example, 5 seconds, etc. However, if not receiving the signal indicative of capture of synchronization from the display 2 still, the program is ended, and the program may be re-started, in case when receiving predetermined information, such as, a signal indicating the power source turned ON or the like, for example, from the display 2.

On the other hand, when receiving a signal indicative of capture of synchronization from the display, by means of the audience determine portion 14, it is determined on whether the condition is “in audience” or not, wherein the information is displayed (S401). Under the condition where only the waiting power source is turned ON or the like, i.e., when the audience determine portion 14 determines that it is not “in audience”, then determination is made on whether it is the time or not, which is determined in advance, i.e., the time for starting a preparatory search, with using the timer 12 (S402). In that instance, if it is the time determined in advance, a control signal is transmitted, for requesting start of execution of the preparatory search to the display 2, and thereby executing the preparatory search (S403). However, since the control signal is small in the data capacity thereof, a possibility is high that transmission of that signal can be made, even in the case where the wireless network quality is bad, due to inappropriate adjustment of the beam direction.

In the preparatory search executed in S403, the adaptive array antennas of both the tuner unit 1 and the display 2 try all of the beam patterns that they can take, so as to estimate the network quality of the wireless network 3 for each of the beam patterns, and after being added with priority thereto, in the sequential order of favorableness of the qualities thereof, they are recorded by the name of beam pattern information.

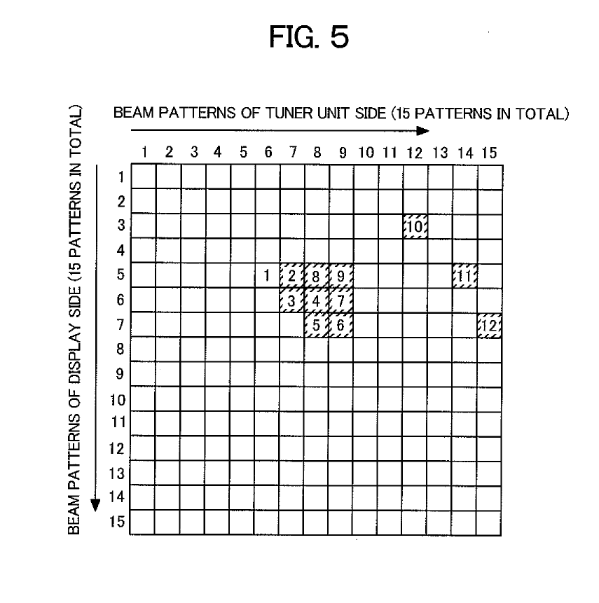

FIG. 5 shows an example of combination of the beam pattern between the adaptive array antennas 11 and 21. In the example shown in FIG. 5, the adaptive array antennas 11 and 21 are able to form 15 sets of the beams, respectively, and when combining those on the side of the tuner unit 1 and those on the side of the display 2, a number of patterns of the beam forming comes up to the second power of 15 (=225) sets in total.

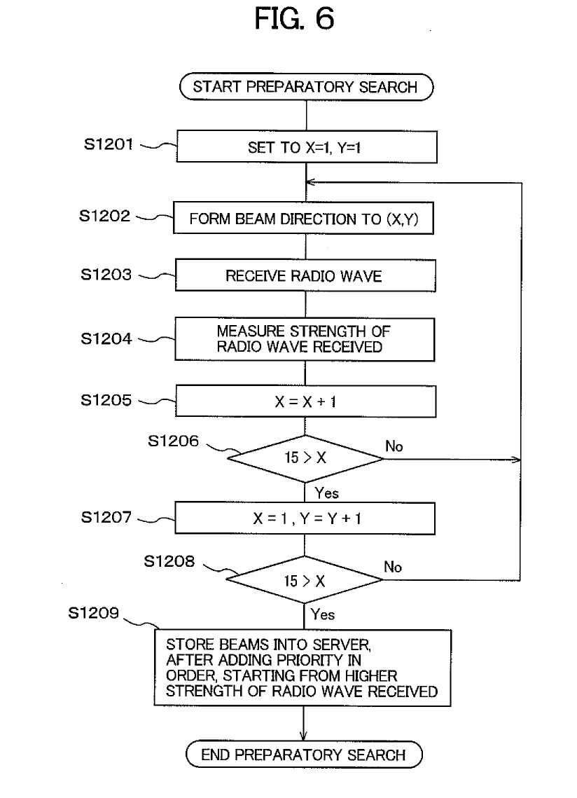

Herein, when constructing the wireless network with using a beam pattern 5 of the adaptive array antenna 11 and a beam pattern 6 of the adaptive array antenna 21, for example, it is assumed that the beam patterns of both are presented by (X=5, Y=6). Also, numerals described on the grid pattern shown in FIG. 5 represent the priority added to the beam pattern information. It indicates that the priority is high, in the sequential order, such as, 1, 2, 3 . . . , for example. In the example shown in FIG. 5, the beam pattern information having the highest priority is (X=5, Y=6), and the beam pattern information having the next highest priority is (X=5, Y=7). FIG. 6 is a flowchart for showing an example of processing in the preparatory search (S403). When starting the preparatory search, (X=1, Y=1) is set as the beam pattern information, for example, (S1201), and at the same time, a control signal requesting transmission of radio wave is transmitted to the display 2, together with a control signal instructing setup of the beam direction of the adaptive array antenna 21 (S1202).

When the adaptive array antenna 11 receives the radio wave transmitted from the adaptive array antenna 21 (S1203), the wireless network estimate portion 13 measures the strength of the radio wave received (S1204). Next, after adding “X” by “1” (i.e., (X=2, Y=1) (S1205), it is determined if “X” exceeds the beam pattern number of the adaptive array antenna 11 or not (S1206). If “X” does not exceeds the beam pattern number, the processes of S1202 to S1206 will be repeated.

On the other hand, if “X” exceeds the beam pattern number of the adaptive array antenna 11, “X” is turned back to “1”, and “Y” is added by “1” (S1207). If “Y” does not exceeds the beam pattern number of the adaptive array antenna 21 (“No” in S1208), then the processes S1202 to S1207 will be repeated.

If “Y” exceeds the beam pattern number on the side of the tuner unit 2 (“Yes” in S1208), among 225 sets of the beam patterns of (X=1, Y=1) to (X=15, Y=15), the beam pattern information added with the priority in the sequential order, from the beam direction having the high strength of the radio wave received, are reversed in the server 15 (S1209). And, in S1209, the controller portion 16 controls so as to transmit the beam pattern information to the display 2. The display 2 reserves the beam pattern information received in the server 25.

However, if the tuner unit 1 and the display 2 are connected by another network, such as, a LAN, for example, therebetween, in addition to the connection by means of the wireless network 3, then the beam pattern information may be transmitted with using another network. Also, the beam pattern information should not be restricted to the case when reserving it into both of the servers 15 and 25, but it may be reserved into only one of them, and wherein the beam pattern information read out from that server may be transmitted to the other apparatus, when adjusting the beam direction.

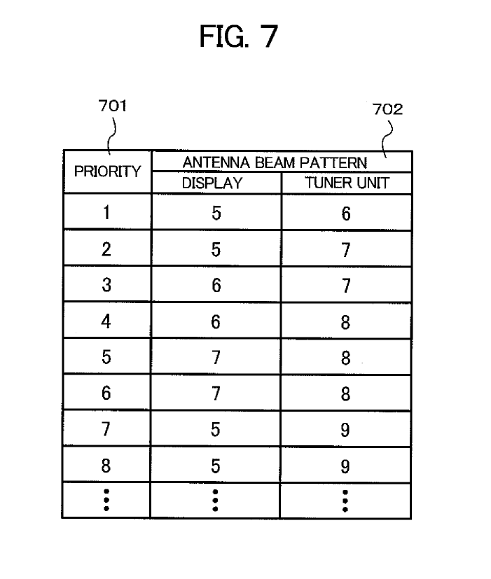

FIG. 7 shows an example of the beam pattern information. In the beam pattern information are recorded the beam patterns of the adaptive array antennas 11 and 21, aligned in the order of height of the priority 701. However, it cannot be said that a preferable accuracy can be achieved by only one (1) time of search. Then, it is preferable that the search is repeated by a plural number of times, and after adding the priority thereto, in the order of an averaged height of the network quality, they are stored in the servers 15 and 25, as the beam pattern information.

Next, explanation will be made on the case of determining that the display 2 is “in audience”, in S401 of FIG. 4.

When determining to be “in audience” by the audience determine portion 14 (“No” in S401), the priority “N” is set to “1” (S404), and the beam pattern information is obtained of the priority “N” (=1) from the server 15 (S405). With using this information, the beam direction of the adaptive array antenna 11 is controlled, and also, a control signal requesting the transmission of radio wave is transmitted to the display, together with a control signal instructing setup of the beam direction of the adaptive array antenna 21 (S406).

Estimation is made if the network quality of the wireless network 3 with using the beam pattern formed satisfies a predetermined value or not, by measuring the strength of the received radio wave, which is transmitted from the adaptive array antenna 21, by means of the wireless network estimate portion 13 (S407). In case where the network quality satisfies the predetermined value, then determination is made on whether the video data is already “in audience” or not (S408). In case where no video data is transmitted, the wireless transfer of the video data is started (S409). In the case where the video data is already “in audience”, then the transmission id continued as it is.

On the other hand, if the network quality does not satisfy the predetermined value, after adding the priority “N” by “1” (S410), determination is made on whether it exceeds or not the number of all the beam patterns (herein, it is assumed to be “K”) (S411). If “N” is equal to or less than “K” (“No” in S411), then the beam pattern information of the priority “N” is obtained from the server 15 (S412), and upon basis of that information, the beam direction of the adaptive array antenna 11 is controlled, and also, the control signal requesting the transmission of radio wave is transmitted to the display, together with the control signal instructing setup of the beam direction of the adaptive array antenna 21 (S413).

As was mentioned above, first of all, the beam forming is conducted with using the beam pattern being the highest (N=1) of the priority “N”, and an operation of adding the priority “N” by “1” is repeated, in the sequential order of the priority, until when the wireless network satisfies the predetermined value. With doing such the control, the possibility of obtaining the preferable radio quality as soon as possible comes to be high, and thereby lessening the time necessary for adjustment of the beam direction. However, if the case where the network quality is less than the standard value is generated by a number of times, equal to or greater than a predetermined number, irrespective of setting the beam direction of the adaptive array antenna, with using the beam pattern information being high in the priority, then it is preferable to renew the beam pattern information so that the priority of that beam pattern information is lowered down.

If N<K, then it is determined to be the case where there is no wireless network 3 satisfying the predetermined value even if using all of the beam pattern information (“Yes” in S411), then a normal beam search is executed (S414). After completing the normal beam search, if the network quality of the wireless network 3 satisfies the predetermined value (“Yes” in S415), then determination is made on whether the video data is already “in audience” or not (S416). In case where no video data is transmitted, the wireless transfer of the video data is started (S417). In the case where the video data is already “in audience”, then the transmission id continued as it is.

Herein, the normal beam search in S414 means, as is done in the preparatory search, forms the beam patterns of the adaptive array antennas 11 and 21, one by one, like (X=1, Y=1), (X=1, Y=2), (X=1, Y=3), for example, i.e., searching the wireless network having the network quality equal to or greater than the predetermined value. In this manner, since the network quality is measured after forming the beam patterns one by one, in the normal beam search, it takes much time until searching out the network having the network quality equal to or greater than the predetermined value, comparing to the method of obtaining the beam pattern information and forming the beams of the antennas with using that information. During the time until when the beam search is completed, since it is impossible to transfer the video data, wirelessly, during the normal search, it is preferable to display a notice to the user, on the display 2, such as, “Under Searching Network. ◯ seconds until end.”, etc.

However, after executing the steps of S402, S403, S408, S409, S416 and S417, the process moves to S418, and if elapsing a predetermined time period, turns back to S401, and thereby repeating the processes.

Also, in the example shown in FIG. 4, the tuner unit 1 controls the setup of the beam direction of the adaptive array antenna 21 of the display 2, however the present invention should not be limited only to this. The display 2 may control the setup of the beam direction within the tuner unit 1. In that instance, within the flow shown in FIG. 4, it is necessary to change S406 and S416 to a step for determining on whether the video information is “in audience”, or not, and to change S409 and S417 to a step for requesting transmission of the video information. Also, after the timers 12 and 22 are time-synchronized with each other, in the tuner unit 1 and the display 2 may be conducted a process, respectively, for adjusting the beam direction. However, if the wireless communication system includes a plural number of displays therein, since it is necessary to adjust the beam direction by taking prevention of interference into the consideration thereof, therefore it is preferable to control it by the tuner unit 1.

With the wireless communication system explained in the above, recording is made on the beam pattern information, which is obtained by executing the preparatory search in the case where the display 2 is “in non-audience” condition, and the beam direction is adjusted, with using this beam pattern information; therefore, it is possible to shorten the time necessary for the beam forming even if an obstacle occurs on the wireless network due to an obstruction or change of wireless environment.

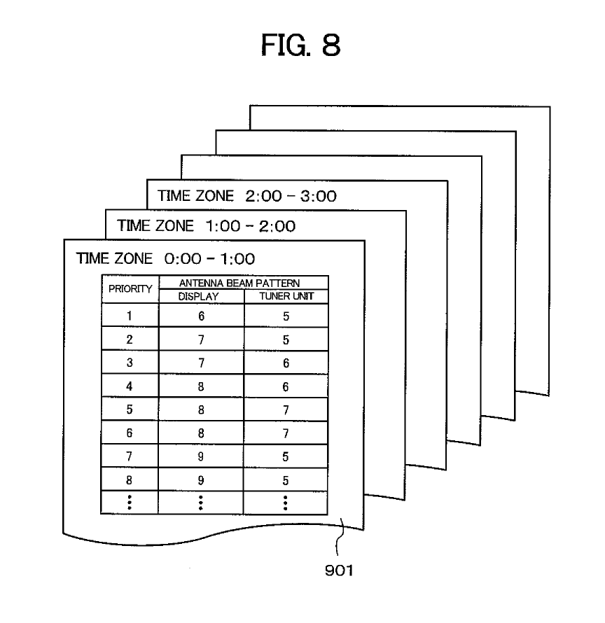

However, in many cases, there is regularity in the wireless environment, depending on time zones, for example, the place differs from where a human being stands or a window or a blind is opened, etc., therefore as is shown in FIG. 8, the beam pattern information may be memorized for each of the time zones. In this instance, in S405 of FIG. 4, the beam pattern information is obtained from the server corresponding to the time zone of the present time. With this, it is possible to use the beam pattern information depending on the environment, and then to increase the possibility of further reducing the time necessary for adjusting the beam direction. However, not being limited to the time zone, the beam pattern information may be memorized depending on a season, a day of the week, weather and the combination thereof.

Also, in the present embodiment, the wireless communication system is constructed with the tuner unit and the display; however, the present invention should not be restricted to this. Thus, this may be applied into a wireless transfer between other apparatuses, other than the tuner unit and the display applying the antennas, directivity of which can be controlled, dynamically. Further, this should not be limited to the wireless transfer between two (2) points, and may be applied in the wireless transfer among three (3) points or more. Also, this should not be limited to the wireless transfer between the apparatuses, applying the antennas, directivity of which can be controlled, dynamically, in both the transmitter side and the receiver side, but may be applied in the case where either one of those apparatuses uses the antenna, directivity of which can be controlled, dynamically.

Also, in the example shown in FIG. 4, though the beam pattern information is produced with using the preparatory search; but the present invention should not be limited to this. For example, in addition to the preparatory search, the beam pattern information may be produced with using a carrier sensing. Herein, the carries sensing means to detect interference waves and/or presence/non-presence of radio wave noises and the amplitude thereof, and/or how much of data loss is generated due to the network obstruction, during a predetermined time (for example, 1 minute) for each beam pattern, after trying all the beam patterns obtainable by the adaptive array antennas of both the tuner unit 1 and the display 2, while continuing to receive the radio waves on both the tuner unit 1 and the display 2.

For example, there may be a case where the network obstruction occurs frequently due to going in and out of the human being, even through the network quality is preferable when the obstruction is generated, then it is not always true that the network having a preferable network quality of the wireless network 3 hardly receive the obstruction. Also, with the wireless communication, in particular, applying an ISM (Industry-Science-Medical) band therein, there are many radio wave noises from other wireless systems, such as, a codeless phone, the Bluetooth, a wireless LAN (Local Area Network), a weather radar, etc., for example, or due to equipment generating the radio waves, such as, an electronic (or microwave) oven, etc.; therefore, when starting the wireless transfer, it is important to use or select a network having less influence of the interference waves and the radio wave noises from other wireless system. Then, the preparatory search is executed, and when memorizing the beam pattern information, the priority is provided or determined by taking, not only the priority determined upon the network quality of the wireless network, but also a frequency of generating obstacles on the network, into the consideration thereof; therefore, it is possible to prevent data loss, and also to suppress that the present system to obstruct the communication of other wireless system.

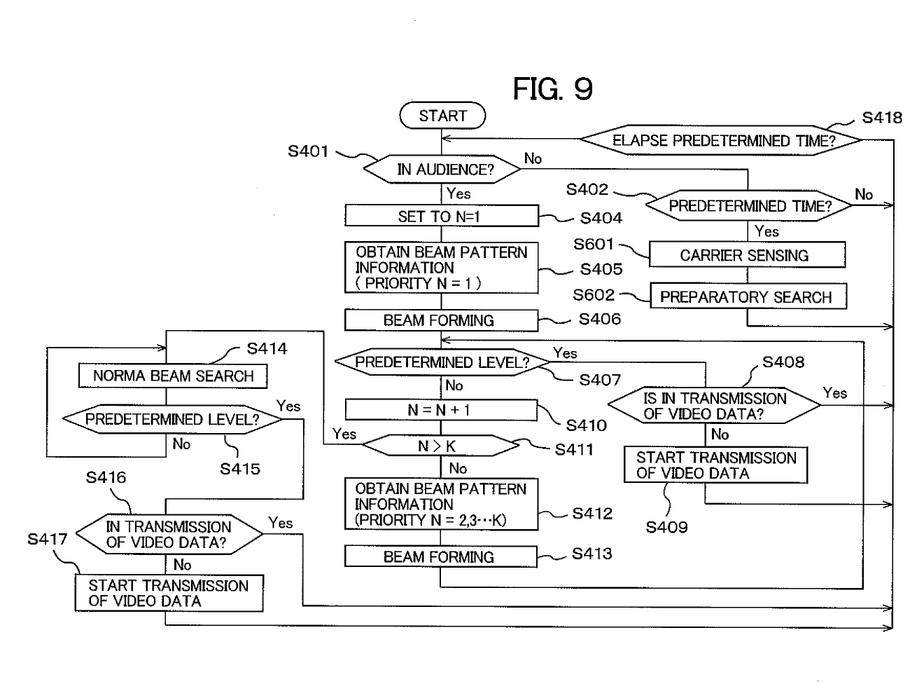

Hereinafter, explanation will be made on a method for producing the beam pattern information with using the carrier sensing, and also for adjusting the beam direction, by referring to FIG. 9. However, in FIG. 9, the same elements shown in FIG. 4 are attached with the same reference numerals, and the explanation thereof will be omitted herein.

In the example shown in FIG. 9, when the audience determine portion 14 determines it is “in non-audience” (“No” in S401), and when the timer 12 determines that it is the time determined in advance (“Yes” in S402), the carrier sensing is executed (S601).

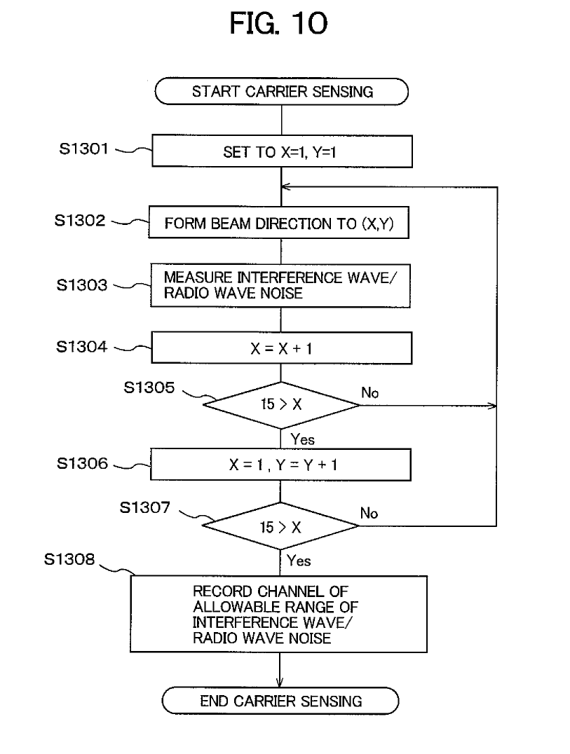

FIG. 10 is a flowchart for showing an example of processing of the carrier sensing in S601. When starting the carrier sensing in S601, selection is made on (X=1, Y=1) (S1301), among the beam patterns shown in FIG. 5, the beam directions of the adaptive array antennas 11 and 21 are formed into (X=1, Y=1) (S1302). Next, during a time period of the predetermined time (for example, 1 minute), the wireless network estimate portion 13 measures the radio wave environment of the wireless network 3 using the beam pattern formed (S1303), such as, the presence/non-presence of the interference waves and the amplitude thereof, etc., for example. And, the measurement is conducted on the wireless environment for all the beam patterns, while repeating S1302 to S1307 with changing the values of “X” and “Y”. And, a combination of the beam directions, which are less influenced from the interference waves and the radio wave noises, is stored in the servers 15 and 25 (S1308).

In the preparatory search in S602, differing from the preparatory search in S403, it is enough to measure the strength of radio wave received of the radio waves formed by the combination of the beam directions, which is determined to be less in the influence from the interference waves and the radio wave noises through the carrier sensing. For this reason, according to the present embodiment, it is possible to select the (anti-obstruction) wireless network, on which the network obstruction is hardly generated, and with this, it is possible to prevent the data loss caused due to the radio wave noises. Also, it is possible to shorten the time necessary for the preparatory search. However, in the example shown in FIG. 9, though explaining that the carrier sensing is executed every time before the preparatory search, but the present invention should not be limited to this. For example, it may be executed one (1) time per a predetermined period or a predetermined number of times, for example, one (1) time per one (1) day. With control in this manner, it is possible to shorten a renewal time of the beam pattern information.

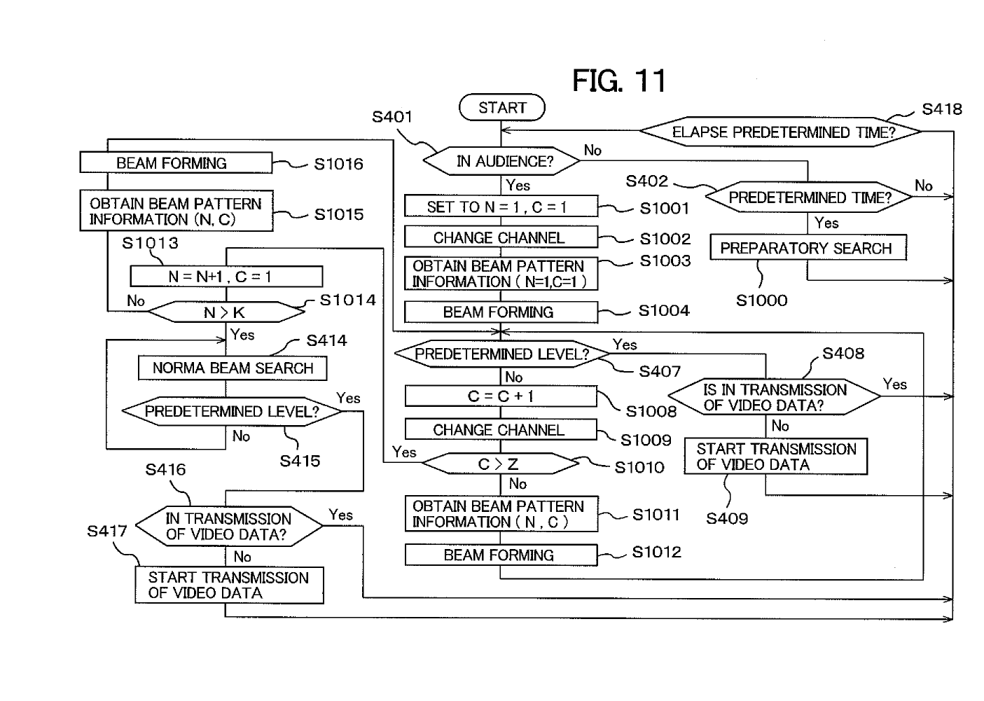

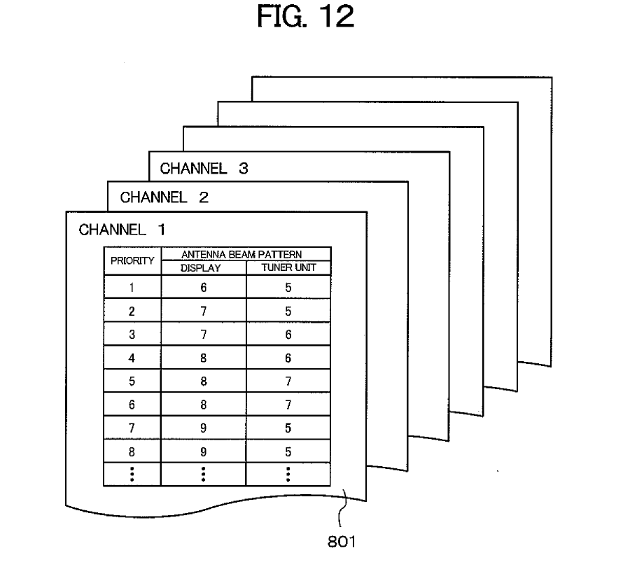

With the embodiment explained in the above, there is only one (1) channel of the wireless network 3 for transferring data wirelessly, but the present invention should not be limited to this, and the present invention can be applied into a system having a plural number of channels therein. Hereinafter, explanation will be made on an embodiment for adjusting the beam direction, within the wireless communication system of enabling to select an arbitrary channel among a plural number of channels, by referring to FIG. 11. However, in FIG. 11, the elements being same to those shown in FIG. 4 are attached with the same reference numerals, and the explanation thereof will be omitted herein. When the audience determine portion 14 determines it is “in non-audience” (“No” in S401), and when the timer 12 determines that it is the time determined in advance (“Yes” in S402), the carrier sensing is executed for each channel, and as is shown in FIG. 12, for each channel, the beam pattern information is memorized in the servers 15 and 25 (S1000). When the channel differs from, since the wireless environment is also changed, greatly, in many cases, therefore it is possible to determine the beam direction, appropriately, by obtaining the beam pattern information for each channel.

When the audience determine portion 14 determines it is “in audience” (“Yes” in S401), the priority “N” is set to “1” and the channel “C” is set to “1” (S1001). Herein, it is assumed that the priority “N” is from 1 to K and the channel “C” from 1 to Z.

Next, after changing the channel to be used to the channel “C” (=1) (S1002), the beam pattern information of the priority “N” (=1) and the channel “C” (=1) is brained from the server 15 (S1003). With using the information obtained, control is made on the beam direction of the adaptive array antenna 11, and to the display 2 are transmitted a control signal requesting transmission of the radio wave, as well as, a control signal instructing setup of the beam direction of the adaptive array antenna 21 (S1004).

In case where the network quality of the wireless network 3 applying the beam pattern formed therein does not satisfy the predetermined value (“No” in S407), after adding the channel “C” by one (1) (S1008), the channel to be used is changed (S1009), and it is determined on whether it does not exceeds the number “Z” of all the channels (S1010). In case where “C” is equal to or less than “Z” (“No” in S1010), the beam pattern information of the priority “N” and the channel “C” is obtained from the server 15 (S1011), and upon basis of that information, control is made on the beam direction of the adaptive array antenna 11, and to the display 2 are transmitted the control signal requesting transmission of the radio wave, as well as, the control signal instructing setup of the beam direction of the adaptive array antenna 21 (S1012).

On the other hand, in case where “C” exceeds “Z” (“Yes” in S1010), after adding the priority “N” by one (1) (S1013), if “N” does not exceeds “K” (“No” in S1014), the beam pattern information of the priority “N” and the channel “C” is obtained from the server 15 (S1015), and upon basis of that information, control is made on the beam direction of the adaptive array antenna 11, and to the display 2 are transmitted the control signal requesting transmission of the radio wave, as well as, the control signal instructing setup of the beam direction of the adaptive array antenna 21 (S1016).

As was mentioned above, by memorizing the beam pattern information for each channel, and conducting the beam forming by changing the channel, sequentially, with using the beam pattern information of the highest priority (N=1) at first, it is possible to determine or set up the wireless network having a preferable network quality. However, in the place of conducting the preparatory search in S403, S601 and S602 shown in FIG. 6 may be executed; thereby producing the beam pattern information with using the carrier sensing. Also, when memorizing the beam pattern information for each channel, as is shown in FIG. 9, for example, the beam pattern information may be memorized depending on the time zone, etc. Further, when memorizing the beam pattern information for each channel in S403, it is preferable to give an order of priority for each channel. With this, it is possible to determine or set up a preferable wireless network in an early stage.

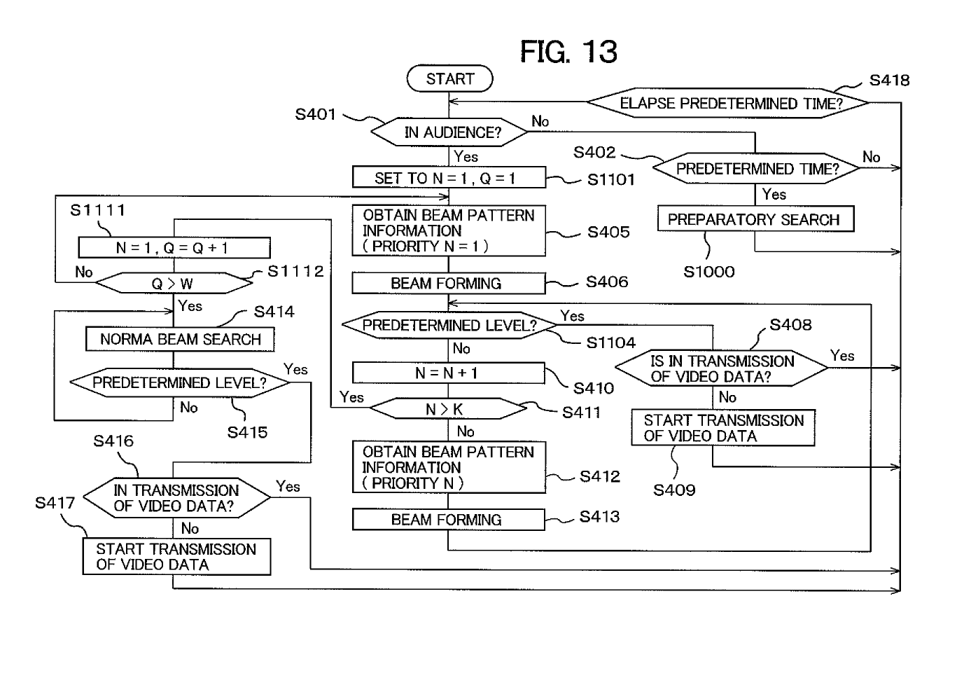

However, when transferring the video data wirelessly, in many cases, the network capacity is changed, dynamically, depending on the video quality of the video data to be transferred and/or the wireless environment. For example, when transferring the video data of high quality, wirelessly, the network capacity is necessary, being higher than that when transferring the video data of normal quality wirelessly. Also, though the network capacity can be taken to be large under a preferable wireless environment, but under a poor wireless environment, there is a limit on the network capacity. Such changes of the network capacity are executed, with changing the occupying frequency band (plural channel use), or changing the demodulation method, etc. Then, hereinafter, explanation will be made on an example of adjusting the beam direction, within the wireless communication system for changing the network capacity thereof, by referring to FIG. 13. However, in FIG. 14, the elements same to those shown in FIG. 4 are attached with the same reference numerals and the explanation thereof will be omitted herein.

In the flowchart shown in FIG. 13, when the audience determine portion 14 determines it is “in audience” (“Yes” in S401), the priority “N” is set to “1” and the network capacity “Q” to “1” (S1101). Herein, it is assumed that the network capacity “Q” is from 1 to W, and that the network capacity has the widest band when “Q”=1 (i.e., able to wireless transfer of the video data of high quality), and that the network capacity comes to be narrow as “Q” increases. Accordingly, the network capacity comes to the narrowest when the network capacity “Q”=W, but the wireless transfer can be done even under the hardest radio wave environment. According to the present embodiment, the wireless network estimate portion 13 has the predetermined value for each network capacity “Q”, and the wireless network estimate portion 13 determines on whether the network capacity of the wireless network 3 applying the beam pattern therein, which is formed in S405 and S406, satisfies or not the predestined value assuming that the network capacity “Q” (=1) (S1104).

When the network quality does not satisfies the predetermined value (“No” in S1104), after adding the priority “N” by “1” (S410), it is determined on whether “N” exceeds “K” or not (S411). In case when “N” exceeds “K” (“Yes” in S411), after adding the network quality “Q” by “1” (S1111), it is determined on whether “Q” exceeds “W” or not (S1112). If “Q” does not exceeds “W” (“No” in S1112), the network capacity is narrowed, and the similar operations are executed. With processing in this manner, it is possible to adjust the beam direction by taking the network capacity into the consideration.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A wireless communication system, comprising:
a first wireless communication apparatus; and
a second wireless communication apparatus, wherein
the first wireless communication apparatus comprises:
a first antenna, which is able to control a beam into a plural number of directions;
a first estimate portion, which estimates a network quality of a wireless network with using a radio wave transmitted from the second wireless communication apparatus;
a first memory portion, which memorizes a beam pattern information including information indicative of priorities of the plural number of beam directions upon basis of the network qualities estimated by the first estimate portion; and
a first controller portion, which controls the first antenna, the first estimate portion and the first memory portion, wherein
the first controller portion controls the beam direction of the first antenna upon basis of the beam pattern information memorized in the first memory portion.

2. The wireless communication system, as described in the claim 1, wherein
the first wireless communication means is a transmitter apparatus, which transfers data, and the second wireless communication apparatus is a receiver apparatus, which received the data transferred by the first wireless communication apparatus, and
the first controller portion executes a search for estimating the network quality of the wireless network for each of the plural number of beam directions of the first antenna, when no data transfer is made from the first wireless communication apparatus, and thereby controlling so that the beam pattern information is produced upon basis of the network quality obtained in the search.

3. The wireless communication system, as described in the claim 1, wherein
the first wireless communication means is a transmitter apparatus, which transfers data, and the second wireless communication apparatus is a receiver apparatus, which received the data transferred by the first wireless communication apparatus, and
the first controller portion executes a search for estimating the network quality of the wireless network for each of the plural number of beam directions of the first antenna, when no data transfer is made from the first wireless communication apparatus and the second wireless communication apparatus is not in a receipt waiting condition, and thereby controlling so that the beam pattern information is produced upon basis of the network quality obtained in the search.

4. The wireless communication system, as described in the claim 1, wherein
the second wireless communication apparatus comprises a second antenna, which is able to control a beam into a plural number of directions, and
the beam pattern information includes information indicative of priorities about a combination of the beam directions of the first antenna and the beam directions of the second antenna.

5. The wireless communication system, as described in the claim 1, wherein
the beam pattern information includes information indicative of the priorities of the plural number of beam directions for each, at least one condition of a time zone, a season, a day of week and a weather.

6. The wireless communication system, as described in the claim 1, wherein
the beam pattern information includes information indicative of the priorities of the plural number of beam directions for each channel.

7. The wireless communication system, as described in the claim 1, wherein
the first controller portion estimates the network qualities of the wireless networks with using the radio waves transmitted from the second wireless communication apparatus by the first estimate portion, after controlling the beam direction of the first antenna upon basis of the beam pattern information, which is memorized in the first memory portion, and when the network quality estimated by the first estimate portion is less than a predetermined level, controls so as to execute a search for estimating the network quality of the wireless network by the first estimate portion, for each of the plural number of beam directions of the first antenna.

8. The wireless communication system, as described in the claim 7, wherein the predetermined level is changed depending on a network capacity of the wireless network.

9. The wireless communication system, as described in the claim 1, wherein
the first controller portion estimates the network qualities of the wireless networks with using the radio waves transmitted from the second wireless communication apparatus by the first estimate portion, after controlling the beam direction of the first antenna upon basis of the beam pattern information, which is memorized in the first memory portion, and when the network quality estimated by the first estimate portion is less than a predetermined level, controls so as to measure an interference wave or a radio wave noise, select the beam direction less influenced by the interference wave or the radio wave noise among the plural number of beam directions, and execute the search for estimating the network quality of the wireless network by the first estimate portion about the beam direction selected.

10. The wireless communication system, as described in the claim 1, wherein the first wireless communication apparatus is a tuner unit, and the second wireless communication apparatus is a display.

11. A wireless communication apparatus for conducting wireless communication between other apparatus, comprising:
an antenna, which is able to control a beam into a plural number of directions;
an estimate portion, which estimates a network quality of a wireless network with using a radio wave transmitted from the other apparatus;
a memory portion, which memorizes a beam pattern information indicative of priorities of the plural number of beam directions upon basis of the network qualities estimated by the estimate portion; and
a controller portion, which controls the antenna, the estimate portion and the memory portion, wherein
the controller portion controls the beam direction of the antenna upon basis of the beam pattern information memorized in the memory portion.
